(19) United States
(12) Patent Application Publication
(10) Pub. No.: US 2014/0093856 A1
(43) Pub. Date: Apr. 3, 2014

(54) SYSTEM AND METHOD FOR PROVIDING A USER WITH ADVISORY INFORMATION

(71) Applicants: Toshiba Tec Kabushiki Kaisha, Tokyo (JP); KABUSHIKI KAISHA TOSHIBA, Tokyo (JP)

(72) Inventors: Naoki WATANABE, Tokyo (JP); Tomonori IKUMI, Shizuoka (JP); Mika HIRAMA, Tokyo (JP); Masami TAKAHATA, Tokyo (JP)

(73) Assignees: Toshiba Tec Kabushiki Kaisha, Tokyo (JP); KABUSHIKI KAISHA TOSHIBA, Tokyo (JP)

(21) Appl. No.: 14/012,125

(22) Filed: Aug. 28, 2013

(30) Foreign Application Priority Data
Sep. 28, 2012 (JP) 2012-216258

(51) Int. Cl. G09B 3/00

(52) U.S. Cl. CPC G09B 3/00
USPC 434/322

(57) ABSTRACT

According to embodiments, a method for providing a user with information includes storing one or more pieces of advisory information and identification information of each of the advisory information, recognizing a request for advisory information from the user, forming, on a sheet, the advisory information requested by the user, an image corresponding to the identification information of the requested advisory information, and an input region in which feedback from the user can be provided, scanning the image formed on the sheet and the input region in which the user has provided the feedback, and storing the feedback in association with the corresponding advisory information.

### CROSS-REFERENCE TO RELATED APPLICATION

This application is based upon and claims the benefit of priority from Japanese Patent Application No. 2012-216258, filed Sep. 28, 2012, the entire contents of which are incorporated herein by reference.

### FIELD

Embodiments described herein relate generally to a technique to provide a user of a facility with information related to use of the facility.

### BACKGROUND

A conventional training facility provides a system which enables a user to recognize availability of different training machines in the training facility.

In addition, with respect to a user who is newly registered as a member, the user may not know which training machine the user should use to carry out the user's purpose for the training. Therefore, a user needs a help of a trainer or an assistant about which training machine would meet the user's purpose. Also when the number of trainers or the assistants is small, it is difficult to obtain a proper assistance.

### DESCRIPTION OF THE DRAWINGS

FIG. 1 is a schematic view showing a training information providing system according to one embodiment.

FIG. 2 is a block diagram showing one example of a hardware configuration of a kiosk terminal according to the embodiment.

FIG. 3 is a block diagram showing one example of a hardware configuration of a program input terminal according to the embodiment.

FIG. 4 is a block diagram showing one example of a hardware configuration of a support terminal according to the embodiment.

FIG. 5 is a block diagram showing one example of a hardware configuration of a server according to the embodiment.

FIG. 6 is a flowchart showing an example of processes for planning a training program using a program input terminal according to the embodiment.

FIG. 7 is a table showing one example of training program information stored in the server according to the embodiment.

FIG. 8 is a flowchart showing an example of processes for displaying evaluation information on the program input terminal according to the embodiment.

FIG. 9 is a table showing one example of evaluation information stored in the server according to the embodiment.

FIG. 10 is a table showing one example of evaluation information stored in the server according to the embodiment (with trainer ID).

FIG. 11 is a flowchart showing one example of processes for printing the training program performed by the kiosk terminal according to the embodiment.

FIG. 12 is a flowchart showing one example of processes for acquiring evaluation information performed by the kiosk terminal according to the embodiment.

FIG. 13 is a flowchart showing an example of processed performed by the support terminal according to the embodiment.

FIG. 14 is a flowchart showing an example of processes for storing training program information in the server according to the embodiment.

FIG. 15 is a flowchart showing an example of processes for receiving a telegraphic message for requesting evaluation information at the server according to the embodiment.

FIG. 16 is a flowchart showing an example of processes for receiving a telegraphic message for requesting a training program at the server according to the embodiment.

FIG. 17 is a flowchart showing an example of processes for storing evaluation information by the server according to the embodiment.

FIG. 18 is a flowchart showing an example of processes for receiving a telegraphic message for requesting support information at the server according to the embodiment.

### DETAILED DESCRIPTION

According to an embodiment, a system which provides sufficient assistance to a user is provided.

In general, according to one embodiment, a method for providing a user with information includes storing one or more pieces of advisory information and identification information of each of the advisory information, recognizing a request for advisory information from the user, forming, on a sheet, the advisory information requested by the user, an image corresponding to the identification information of the requested advisory information, and an input region in which feedback from the user can be provided, scanning the image formed on the sheet and the input region in which the user has provided the feedback, and storing the feedback in association with the corresponding advisory information.

In one embodiment, to enable a user to efficiently exercise training, the user is allowed to print out a training program from one or more terminals provided in a facility (hereinafter referred to as kiosk terminals). Further, in one embodiment, a terminal into which training programs are input and a terminal for supporting the training are prepared for every trainer who plans the training program and every assistant who assists the trainer, respectively. Due to such terminals, the trainer, the user who exercises the training (hereinafter referred to as a trainee), and the assistant can act efficiently such that the trainer can efficiently plan the training program, the user can efficiently exercise the training program and the assistant can efficiently support the trainee's exercise.

Hereinafter, the embodiments are explained.

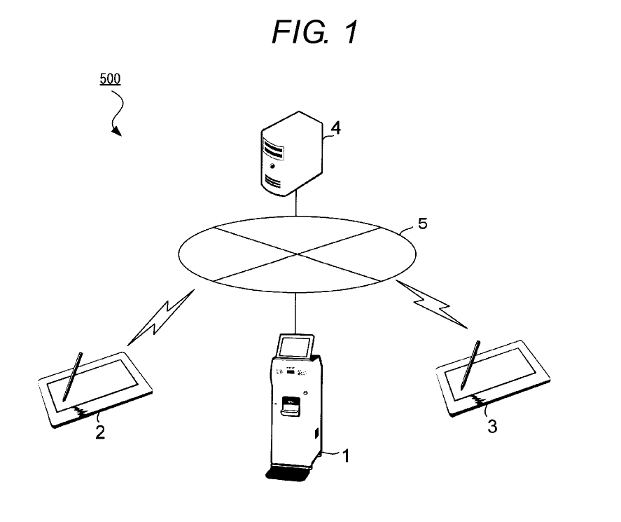

A training information providing system according to one embodiment is configured as shown in FIG. 1. The training information providing system 500 includes: one or more kiosk terminals 1 which are located in a facility where a user exercises a training; a program input terminal 2 which is provided to each trainer who plans a training program; and a support terminal 3 which is provided to each assistant who supports the training. The training information providing system 500 includes a server 4 which is installed for every facility and controls information such as a training program and a training state of a trainee. These units are connected to each other through a network 5 including a wired network and a wireless network.

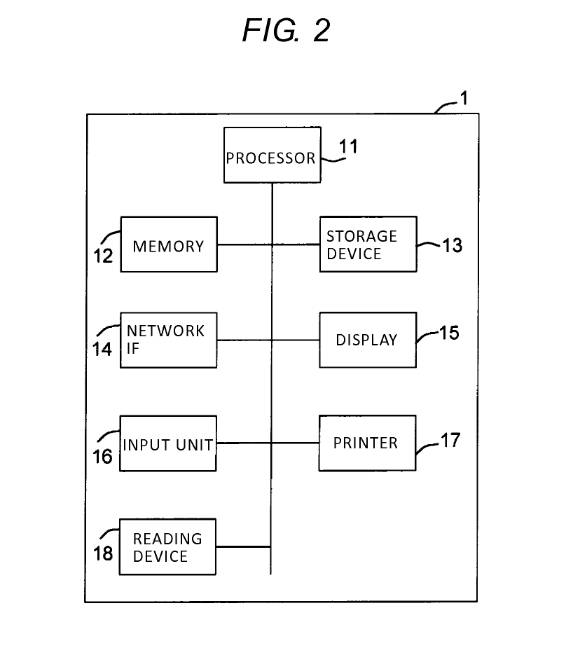

As shown in FIG. 2, the kiosk terminal 1 includes: a processor 11 (CPU: central processing unit, MPU: micro processing unit or the like), which executes a program for providing training information; a memory 12 (Random Access Memory (RAM) or the like), which is a main storage device; and a storage device 13 (flash memory, hard disk drive or the like), which stores a program and training data therein. The kiosk terminal 1 includes a network IF 14 (IF: interface) (LAN card or the like) for establishing a connection between the kiosk terminal 1 and the network 5, and a display 15, which displays a manipulation screen necessary for displaying or manipulating training data. The kiosk terminal 1 also includes an input unit 16 having a touch panel and a keypad with which the trainee manipulates the kiosk terminal 1, and a printer 17, which prints a training program on a sheet. The printer 17 also prints a format on the sheet where the trainee fills the evaluation of the training program. The kiosk terminal 1 also includes an optical reading device 18, which reads the evaluation which is filled on the sheet. Although the sheet is paper in this embodiment, the sheet may be formed of other materials such as plastic.

Information related to a connection between the kiosk terminal 1 and the server 4 (IP address, host name, and the like of the server 4) is stored in a storage device 13 of the kiosk terminal 1. The storage device 13 also stores format data therein, and the format data is formed such that an inquiry about an effect which the trainee achieves by exercising a training program printed by the kiosk terminal 1 and about his or her impression on the training program can be printed. Also in the storage device 13, a reply reading program with which contents filled in the format in accordance with the above-mentioned format are optically read when the trainee fills in the printed format is stored.

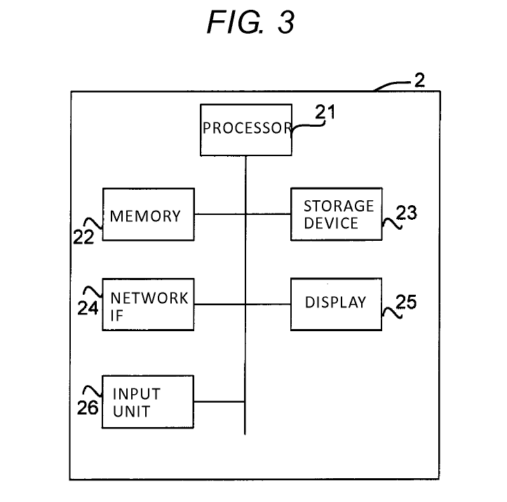

In this embodiment, the program input terminal 2 is a tablet-type terminal device. As shown in FIG. 3, the program input terminal 2 includes: a processor 21 for executing a program, a memory 22, which is a main storage device; a storage device 23, which stores a program and a training program; a network IF 24, which is connected to the network; a display 25, on which the training program input by a trainer and the evaluation of the program are displayed; and an input device 26, which has a touch panel and a keyboard and allows the trainer to input a training program. The program input terminal 2 is associated with a trainer who owns the program input terminal 2. A trainer ID (ID: identification) by which the trainer who owns the program input terminal 2 is identified is stored in the storage device 23, and information related to a connection between the program input terminal 2 and the server 4 is also stored in the storage device 23.

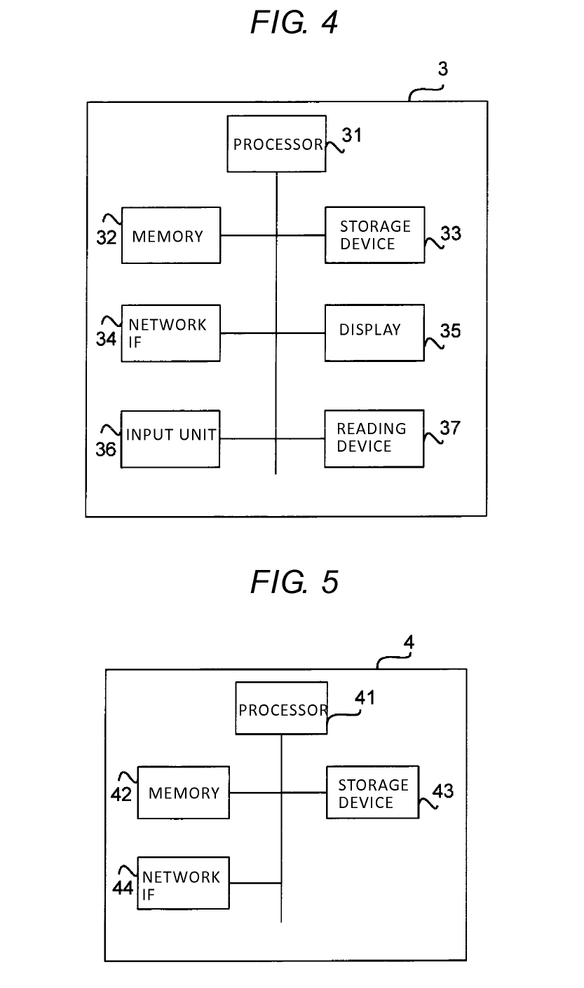

In this embodiment, the support terminal 3 is a tablet-type terminal device. As shown in FIG. 4, the support terminal 3 includes: a processor 31 for executing a supporting program; a memory 32, which is a main storage device; a storage device 33, which stores therein a program and a training program about which a trainee requests support; and a network IF 34, which is connected to the network for downloading information related to a training program based on which a trainee requests support. The support terminal 3 includes: a display 35, which displays thereon training data and a manipulation screen for performing manipulation; an input device 36, which has a touch panel and a keyboard and allows an assistant to perform the manipulation thereof; and an optical reading device 37 for reading a printed code. The support terminal 3 is associated with the assistant, who owns the support terminal 3. An assistant ID by which the assistant is identified is stored in the storage device 33, and connection information for establishing a connection between the support terminal 3 and the server 4 is also stored in the storage device 33.

As shown in FIG. 5, the server 4 includes: a processor 41, which executes a program, a memory 42, which is a main storage device; a storage device 43, which stores a program and data therein; and a network IF 44, which is connected to the network. As a matter of course, the server 4 may include a display and an input device.

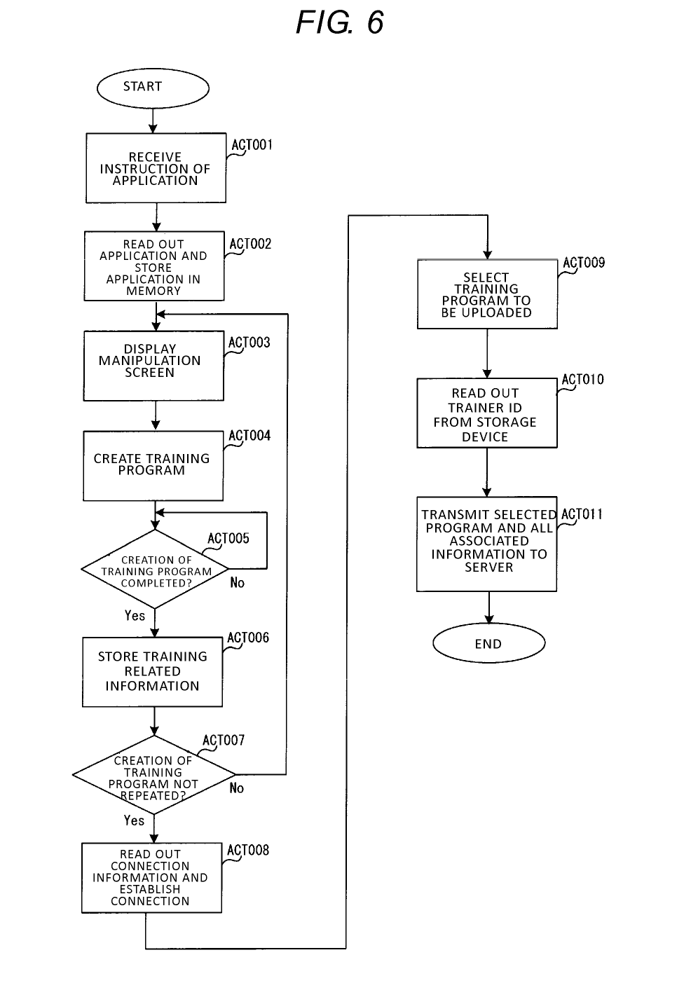

Prior to providing training information using the training information providing system 500, a trainer plans a training program in accordance with a flowchart exemplified in FIG. 6 using the program input terminal 2 with which the trainer's own ID is associated. A selection screen for selecting applications for executing programs which the program input terminal 2 has is usually displayed on the display 25. when the trainer inputs an instruction to execute the training program preparation application out of these applications using the input device 26 (ACT 001), the processor 21 reads out the training program preparation application from the storage device 23, causes the application to be stored in the memory 22, and starts executing the application (ACT 002).

When the program is executed, a manipulation screen is displayed on the display 25 (ACT 003), and a training program is created by the trainer inputting data with the input device 26 (ACT 004, ACT 005). In creating the training program, the name of the training, the purpose of the training, and the specific contents of the training are inputted using the input device 26. Support information, which is a combination of a problem which may occur in exercising the training, a question which a trainee may have, a solution for the problem, and an answer to the question is also simultaneously input using the input device 26.

These data are stored in the storage device 23 in a state where the data are associated with each other (ACT 006). After some training programs are recorded in this manner (ACT 007, Yes), when the uploading of a training program is instructed by the input device 26 on the program preparation application, the program input terminal 2 establishes a connection with the server 4 through the network IF 24 based on the information related to the connection between the program input terminal 2 and the server 4 stored in the storage device 23 (ACT 008). Then, the program input terminal 2 selectively receives the input of a training program out of training programs stored in the storage device 23 through the input device 26 (ACT 009). The program input terminal 2 extracts the selected training program and the name of the training, the purpose of the training, the contents of the training, and support information on the training which are associated with the selected training program, reads out a trainer ID stored in the storage device 23 (ACT 010), and transmits these data and the trainer ID to the server 4 in a state where these data and the trainer ID are associated with each other (ACT 011).

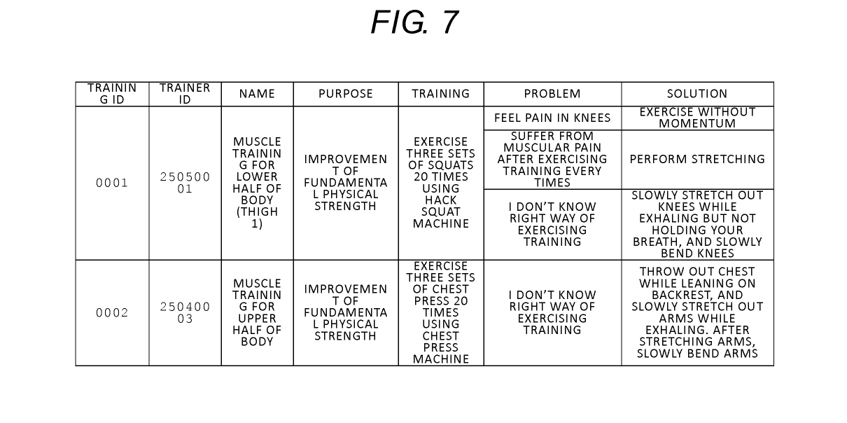

Information shown in FIG. 7 is stored in the storage device 43 of the server 4 due to such a transmission of these data and the trainer ID (the manner of operation of the server 4 being described later). That is, a unique training ID is generated and is stored in the storage device 43 of the server 4 in association with the trainer ID, the name of the training, the purpose of the training, the content of the training, a problem or a question (task), support information related to a solution for the problem, and the question which are transmitted to the server 4.

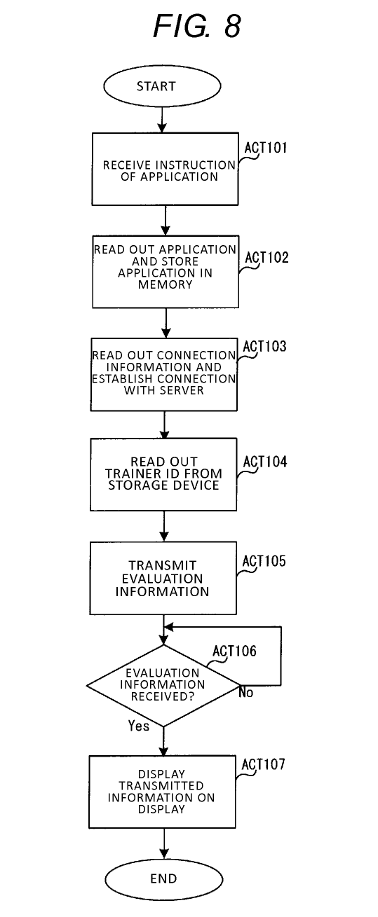

The program input terminal 2 also functions as a device for checking an evaluation of a trainer associated with training program. The manner of operation of such evaluation checking is explained in conjunction with a flowchart exemplified in FIG. 8. When the trainer inputs an instruction of executing the evaluation checking application, which is an application for checking the evaluation of training planned by the trainer himself, using the input device 26 (ACT 101), the processor 21 reads out the evaluation checking application from the storage device 23, causes the application to be stored in the memory 22, and starts executing the application (ACT 102). Due to the execution of such an application, the processor 21 establishes a connection with the server 4 through the network IF 24 based on the information related to a connection between the program input terminal 2 and the server 4 stored in the storage device 23 (ACT 103). The processor 21 reads out a trainer ID stored in the storage device 23 (ACT 104), and transmits the trainer ID so as to download evaluation information associated with the trainer ID, such as the names, evaluation scores, and evaluation contents, of the respective training programs (ACT 105, ACT 106). The processor 21 develops the downloaded evaluation information, and displays the downloaded evaluation information on the display 25 (ACT 107). The contents displayed on the display 25 include an evaluation score which corresponds to a summed-up score with respect to all of the trainings planned by the trainer himself, the summed-up scores of the evaluation scores with respect to each training planned by the trainer, a list of individual evaluation content with respect to each training planned by the trainer, and the like. These contents can be modified as required by manipulation through the input device 26. With such processing, the trainer can check not only the evaluation of the respective training programs but also the evaluation of the trainer himself.

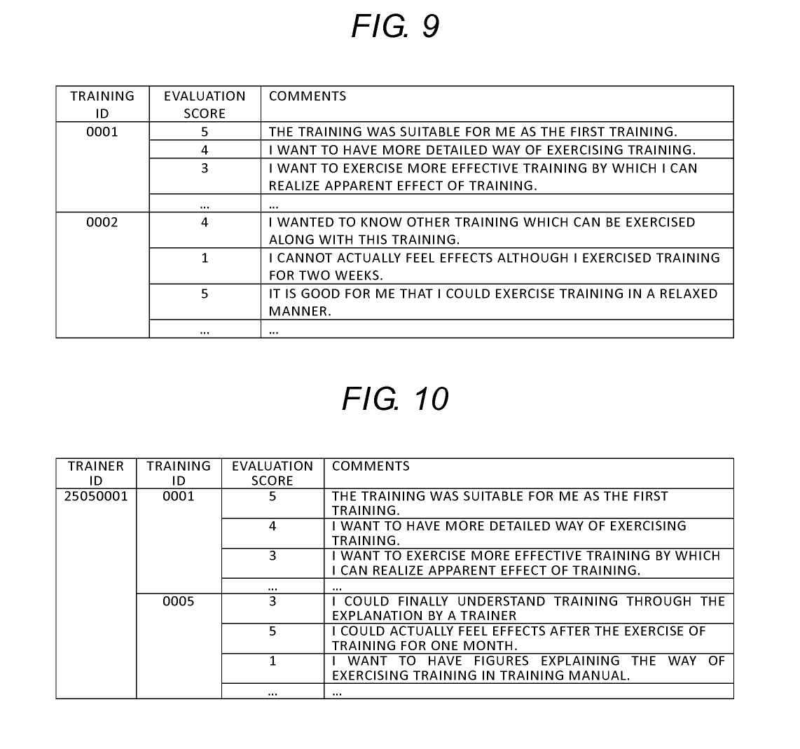

Here, the above-mentioned evaluation information stored in the server 4 is explained in conjunction with FIG. 9. The server 4 stores therein an evaluation score and the evaluation content (comment) which are filled in by a trainee in association with the training ID (the specific operation such as the acquisition of the evaluation being described later). In this embodiment, the evaluation score is an evaluation obtained from a trainee who exercises the training program in the form of a computer-scored answer sheet, and the evaluation is made in five grades ranging from 1 (low evaluation) to 5 (high evaluation). The comment is evaluation data such as the impression of the trainee on training or the like. The comment is obtained in such a manner that a predetermined column on the sheet which is filled in by the trainee with his hand is read out and, then, the content is converted into text data using an optical character reader (OCR) technique. There may be a case where the content is written by hand so that the recognition of a character is difficult. In such a case, the image data obtained by cutting out part of the format in which the comment is filled may be stored in the storage device 43, and link data to the image data (a password impart to the file name) may be registered in association with the comment format shown in FIG. 9. The program input terminal 2 receives such evaluation information in accordance with the flowchart shown in FIG. 8 so that a trainer can check the evaluation with respect to the training content. Further, when a trainer plans a plurality of training programs and the plurality of training programs are registered, as shown in FIG. 10, the evaluation information may be stored also in association with the trainer ID.

When the evaluation information is associated only with the training ID as shown in FIG. 9, the evaluation information can be obtained by deriving a training ID from the trainer ID transmitted from the program input terminal 2 based on the correspondence relationship shown in FIG. 7.

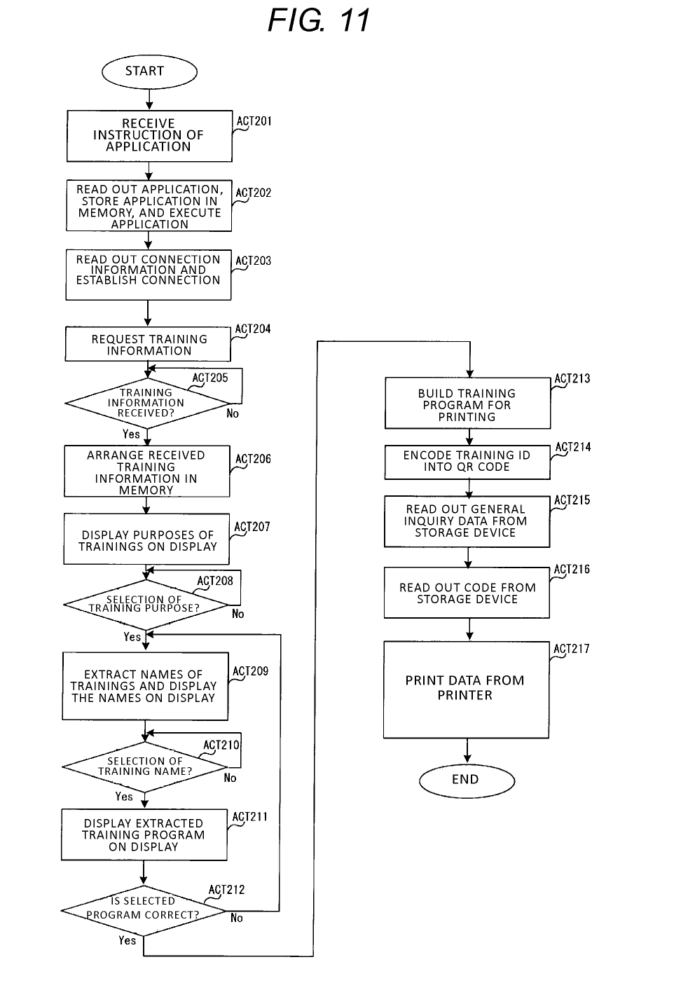

Next, the explanation is made with respect to an operation example ranging from a point of time at which a trainee enters the training facility to a point of time at which the trainee obtains a sheet on which training contents are described in conjunction with a flowchart shown in FIG. 11. After the trainee completes an entry procedure in the training facility, the trainee manipulates the kiosk terminal 1 and selects a training program and obtains a sheet.

In the kiosk terminal 1, when the trainee instructs execution of the training information providing application by inputting the instruction using the input device 16 (ACT 201), the processor 11 reads out the training information providing application from the storage device 13 and causes the training information providing application to be stored in the memory 12, and starts executing the training information providing application (ACT 202). When the execution of the training information providing application is started, the processor 11 establishes a connection with the server 4 via the network IF 14 using the information related to the connection between the kiosk terminal 1 and the server 4, which is stored in the storage device 13 (ACT 203). After the connection is established, the processor 11 requests the server 4 to transmit training information to the processor 11, and waits for a reply from the server 4 (ACT 204, ACT 205). When the processor 11 receives the reply containing training information from the server 4 (ACT 205, Yes), the kiosk terminal 1 receives the training information and causes the training information to be stored in the memory 12 (ACT 206). The information which is transmitted as the reply at this point of time is information extracted from information of training programs stored in the server 4 (shown in FIG. 7), and such information contains a univocal training ID, the name of training, the purpose of corresponding training, and the content of the training associated with the training program. When the location of the training information in the memory 12 is completed, the processor 11 controls the display 15 such that the purposes of the trainings out of the above-mentioned data arranged in the memory 12 are displayed in a form of a list (ACT 207). Data in the list are displayed such that each item is formed of a button (in the form that one item can be selected). When the trainee selects the purpose for which he wants to exercise the training through the input device 16 out of the list of purposes (ACT 208, Yes), the processor 11 extracts the training program corresponding to the selected training purpose from the data stored in the memory 12, and displays a list of names of the training programs on the display 15 such that each name of the training program forms a button (ACT 209). When the name of the training is selected by the trainee selecting the button on the input device 16 (ACT 210, Yes), the content of the corresponding training is extracted from data stored in the memory 12, and is displayed on the display 15 (ACT 211). Further, a manipulation screen which inquires the trainee whether or not he agrees with the displayed content is also simultaneously displayed on the display 15 (ACT 211).

When the selection that the trainee agrees with the content is made by the trainee manipulating the input device 16 (ACT 212, Yes), the processor 11 rebuilds the content of training so as to conform to the printing (ACT 213), and encodes a unique training ID corresponding to the content of the training into a code which is optically readable such as a QR code (ACT 214). In the kiosk terminal 1, in addition to these data, data for printing is formed by including interview data stored in the storage device 13 and an optically readable code which indicates that the code is a sheet for a training program used by the system (ACT 215, ACT 216), and the data for printing is printed by the printer 17 (ACT 217). Accordingly, the kiosk terminal 1 can provide a training program which the trainee desires in a portable form. The interview data is format data which includes text data such as “bad,” “not good,” “ordinary,” “fair,” and “good” for acquiring the above-mentioned evaluation score, a bubble form in the form of a computer-scored answer sheet corresponding to such text data, text data such as “give us your feedback,” and a format in which a comment is filled by the user (free description column).

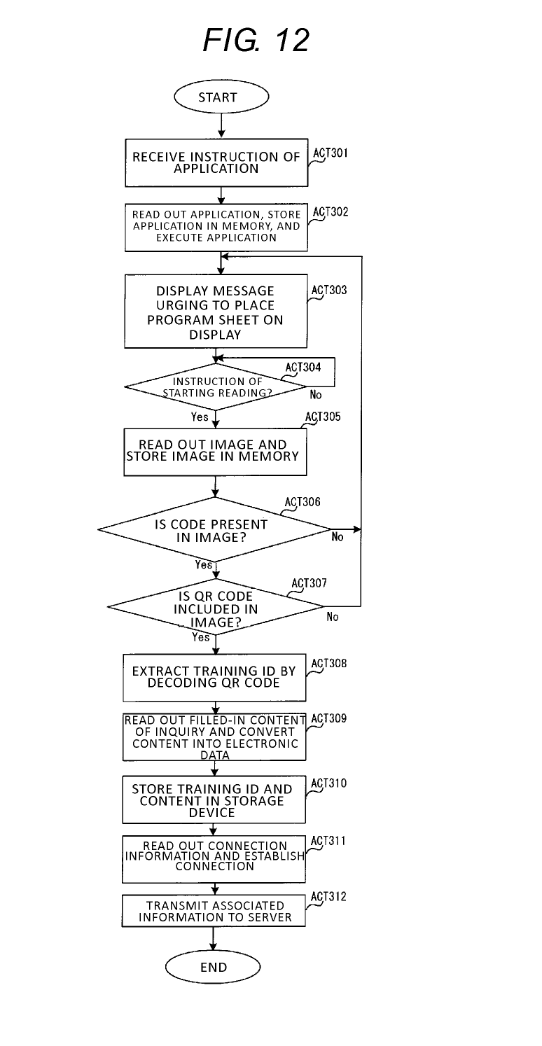

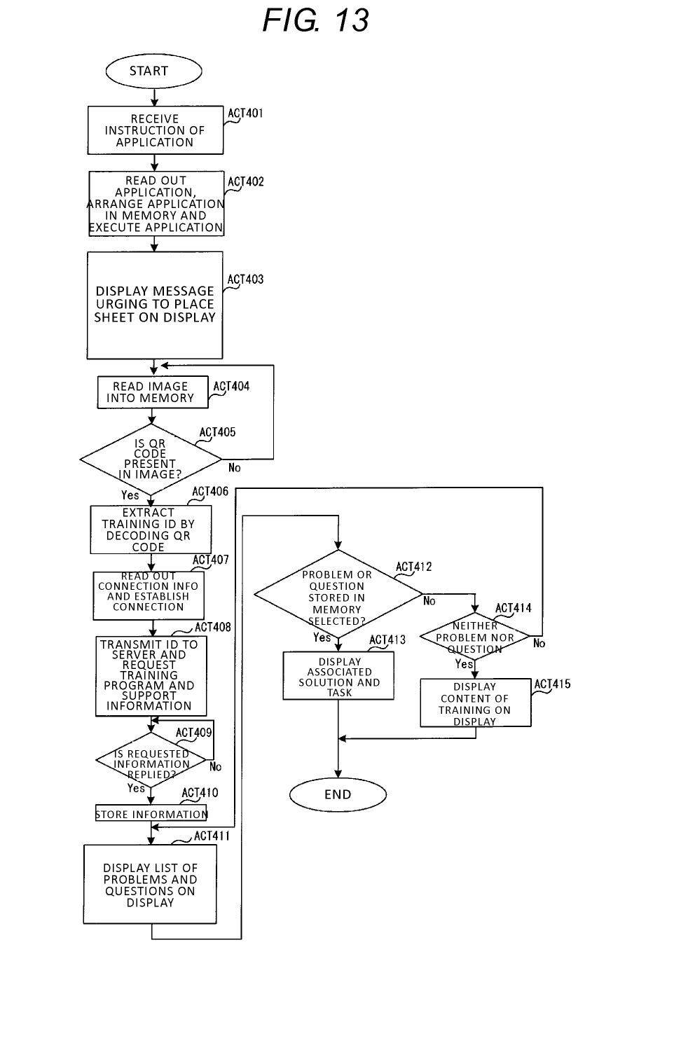

The trainee fills evaluation information in the above-mentioned respective formats by handwriting in the midst of training or after the training. The kiosk terminal 1 can acquire the evaluation information made by the trainee with respect to the training program by reading the formats on the sheet in which the evaluation is filled. FIG. 12 shows an example of the kiosk terminal 1 with respect to these processes.

When the trainee instructs the execution of the interview reading providing application by inputting an instruction using the input device 16 (ACT 301), the processor 11 reads out the interview reading providing application from the storage device 13, and causes the interview reading providing application to be stored in the memory 12, and starts executing the interview reading providing application (ACT 302). Next, the processor 11 controls the display 15 to display a message which urges the trainee to place the sheet on which the training program is printed and in which a questionnaire is filled such that the sheet can be read by the reading device 18, and a manipulation screen for instructing the starting of reading (ACT 303). When a reading start instruction is output through the input device 16 by the trainee (ACT 304, Yes), the processor 11 reads the filled-in sheet placed by the trainee using the reading device 18, and causes an image of the sheet to be stored in the memory 12. The processor 11 executes image processing on the image stored in the memory 12, and checks whether or not the image contains a code which indicates that the sheet is the sheet for a training program used in the system (ACT 306). When the image contains the above-mentioned code (ACT 306, Yes), subsequently, the processor 11 checks whether or not the image contains a QR code indicative of a training ID corresponding to the training program (ACT 307). When the QR code is included in the image (ACT 307, Yes), decoding of the QR code is executed so as to extract the training ID (ACT 308).

Then, the processor 11 reads out the content filled in by the trainee from the image stored in the memory 12, converts the content into electronic data by reading the computer-scored answer sheet or using the optical character recognition (OCR) (ACT 309), and then stores numerical evaluations as evaluation scores and stores the content written in natural sentence by hand writing as the evaluation content in the storage device 13 in a state where the numerical evaluations and the content written in natural sentence are associated with the previously-mentioned training ID (ACT 310). The processor 11 establishes the connection with the server 4 via the network IF 14 using information related to the connection between the kiosk terminal 1 and the server 4, which is stored in the storage device 13 (ACT 311), and transmits data where the above-mentioned filled-in content and the training ID are associated with each other to the server 4 (ACT 312).

Next, an example of processes executed by the support terminal 3 is explained. The support terminal 3 is a terminal owned by an assistant, i.e., a training assistant, and is a terminal which provides a proper solution to a trainee in the case where a question or a problem arises when the trainee is exercising the training. The trainee exercises the training while referring to a training sheet output from the kiosk terminal 1. When a question or a problem arises, the trainee submits this training sheet to the assistant and asks the question. The support terminal 3 operates in accordance with a flowchart exemplified in FIG. 13.

When the assistant instructs execution of the training support application by inputting the instruction using the input device 36 (ACT 401), the processor 31 reads out the training support application from the storage device 33, causes the training support application to be stored in the memory 32, and starts executing the training support application (ACT 402). When the execution of the training support application is started, the processor 31 controls the display 35 to display a message which urges the assistant to place the training sheet such that the reading device 37 can read the training ID printed on the training sheet (ACT 403), and starts up the reading device 37. The processor 31 causes an image read by the reading device 37 to be stored in the memory 32 (ACT 404), and checks whether or not a QR code indicative of a training ID is present on the image (ACT 405). When the QR code is present on the image (ACT 405, Yes), the processor 31 extracts the training ID by decoding the QR code (ACT 406) and, then, the processor 31 establishes the connection with the server 4 via the network IF 34 based on information related to the connection between the support terminal 3 and the server 4, which is stored in the storage device 33 (ACT 407).

The processor 31 transmits the extracted training ID to the server 4, and requests for the training program corresponding to the training ID and support information for training (ACT 408). When the requested information is transmitted to the processor 31 from the server 4 by referring to the correspondence relationship exemplified in FIG. 7 (ACT 409, Yes), the processor 31 causes these information to be stored in the memory 32, and control the display 35 to display problems which may arise at the time of exercising training and questions which the trainee may have among the support information as a list in a form of buttons (ACT 411). An option which indicates that a problem which the trainee has is not any one of these problems is also displayed on the display 35 together with the list.

When the extracted problem or question is selectively input through the input device 36 (ACT 412, Yes), the processor 31 extracts a solution or an answer associated with the problem or the question from the memory 32, and controls the display 35 to display the solution or the answer (ACT 413). When the option indicating that a problem is nether the extracted problem or the extracted question is selected (ACT 412, No, and ACT 414, Yes), the display 35 displays the training program associated with the extracted problem or the question (ACT 415). Due to such a display, even when the trainer is not present, the problem or the question is smoothly answered by the assistant. Also, when the assistant cannot answer the problem or the question, the assistant can seek for more appropriate solution by referencing to the training program.

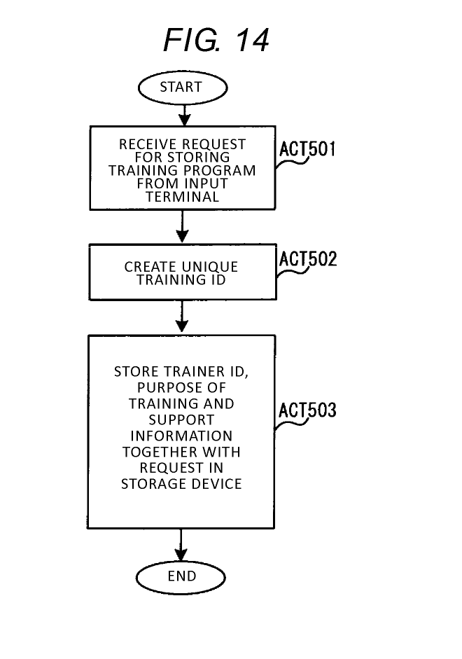

Finally, an example of processes executed by the server 4 is explained in conjunction with a flowchart shown in FIG. 14 to FIG. 18. The server 4 stores or provides information in response to a request from terminals 1 to 3.

FIG. 14 is a flowchart showing processing in storing a training program planned by the trainer (see also FIG. 6). The processor 41 receives a request for storing the training program from the program input terminal 2 via the network IF 44 (ACT 501), and associates the request with the trainer ID, the content of training, support information, and the like, which are transmitted simultaneously. After completing such association, a training ID unique to the transmitted data is prepared (ACT 502), and the training ID is additionally stored in the storage device 43 in association with the above-mentioned data (ACT 503). In this manner, the correspondence relationship shown in FIG. 6 is established.

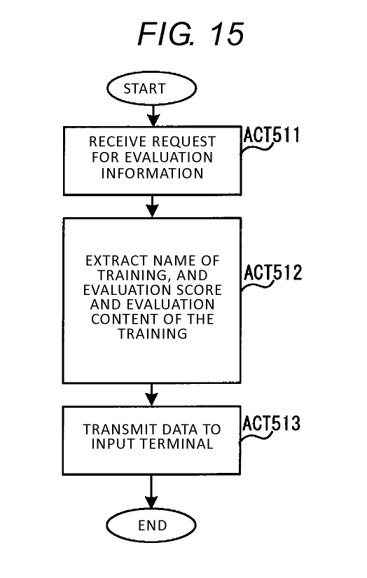

Further, an operation which is performed when the server 4 receives a request for evaluation information from the program input terminal 2 shown in FIG. 8 is performed as exemplified in FIG. 15. When the processor 41 receives a request for evaluation information from the program input terminal 2 via the network IF 44 (ACT 511), the processor 41 extracts an evaluation score and a comment (evaluation content) which are associated with the trainer ID (also training ID being used) which is transmitted together with the request, out of evaluation information of the training program stored in the storage device 43 (ACT 512), and transmits the evaluation score and the comment to the program input terminal 2. That is, the server 4 searches recorded data using the training ID (or trainer ID) based on the correspondence relationship shown in FIG. 9 and FIG. 10, and transmits hit recorded data. Also at this time, the processor 41 may transmit the name of training, the content of training, the training ID, and the like.

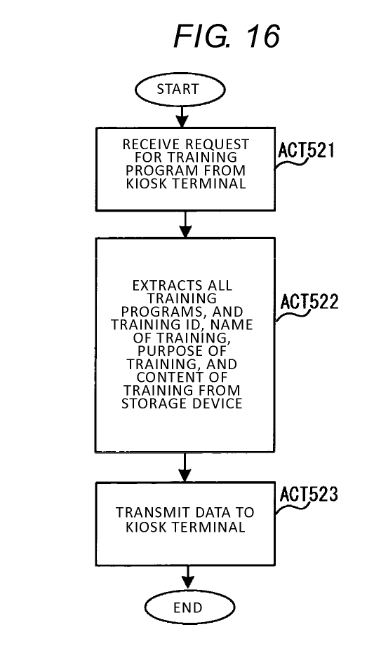

An operation example where a training program is requested through the kiosk terminal 1 exemplified in FIG. 11 is shown in FIG. 16. When the processor 41 receives a request for a training program from the kiosk terminal 1 via the network IF 44 (ACT 521), the processor 41 extracts all of the training Id, the name of training, the purpose of training, and the content of training, each of which is stored in the storage device 43 and exemplified in FIG. 7 (ACT 522), and the processor 41 transmits these data to the kiosk terminal 1 (ACT 523).

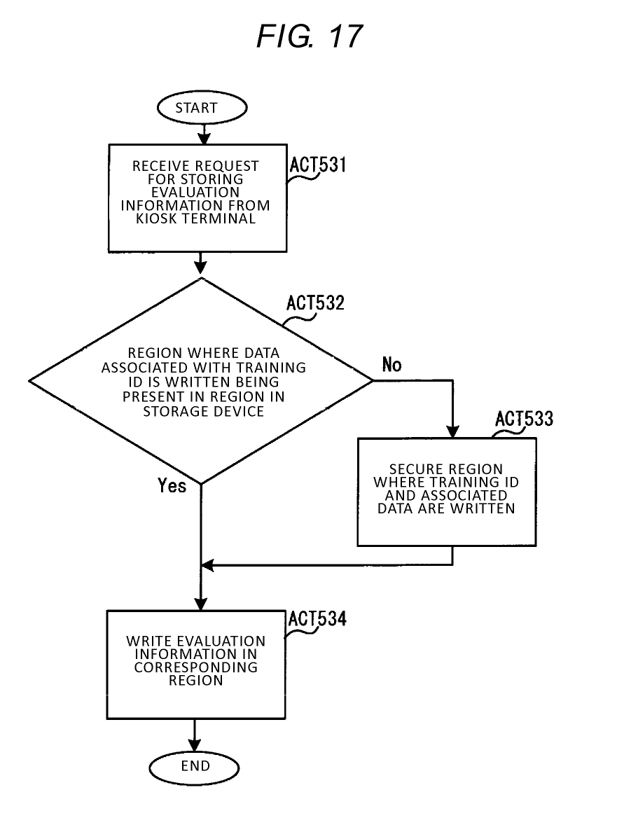

Storing of evaluation information on a training program by the trainee exemplified in FIG. 12 is performed as exemplified in FIG. 17. If the processor 41 receives a request for storing evaluation information on the training program from the kiosk terminal 1 via the network IF 44 (ACT 531), the processor 41 controls the storage device 44 (ACT 534) to store an evaluation score and the evaluation content of training associated with the training ID, which are transmitted simultaneously with the evaluation information, in a portion where the same training ID is present in a region where the evaluation information is recorded (ACT 532, Yes and ACT 534), or such a region is created in the storage device 44 (ACT 533) when the training ID is not present (ACT 532, No) and the evaluation score and the evaluation content are stored in the storage device 44 in association with a new training ID (ACT 534). Due to such processing, the correspondence relationship shown in FIG. 9 and FIG. 10 is established.

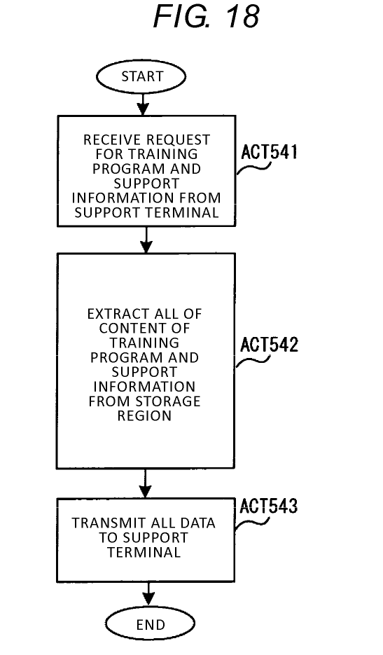

An operation which is performed when support information of the training is requested by the support terminal 3 shown in FIG. 13 is performed as exemplified in FIG. 18. When the processor 41 receives a request for the content of a training program and support information from the support terminal 3 via the network IF 44 (ACT 541), the processor 41 extracts all of the content of the training program associated with the training ID which is transmitted simultaneously with the request and support information associated with the content of the training program (task and solution) by referring to the correspondence relationship shown in FIG. 7 which is stored in the storage device 43 (ACT 542), and transmits these data to the support terminal 3 (ACT 543).

Due to the above-mentioned embodiment, even when a trainer himself is not on a site, the trainer can provide a proper advice to a trainee with respect to the training program which the trainer planned, and also can acquire the trainee's impression on the training which the trainer planned. Accordingly, the trainer can enhance his motivation to improve the training program. Further, according to this embodiment, even when the training is not a training which the trainer plans by himself, it is possible to provide the training program and the estimated support information at any time, and, hence, the efficient communication related to the training program between the trainer and the trainee can be prompted. Further, it is unnecessary for the trainee to directly ask the trainer for a man-to-man training. That is, the trainee can exercise the training program corresponding to a purpose of the training in a more relaxed manner by himself, and can ask for the support from an assistant when necessary. Hence, the trainee can exercise training more effectively in accordance with his pace.

In the above-mentioned embodiment, although the example of using the system is explained by a facility where trainee exercises a training program as an example, the example of the use of the system is not limited to this. For example, by changing the content of data and the name of the column exemplified in FIG. 7, FIG. 9 and FIG. 10, the system can be used in various facilities and hence, the system can support users who use also these facilities.

Further, the device configuration of the system and the allocation of respective functions of the system are not limited to the above-mentioned examples. For example, the kiosk terminal 1 and the server 4 may be arranged in one housing, or the program input terminal 2 and the support terminal 3 may be arranged in one housing thus allowing respective users to use the program input terminal 2 and the support terminal 3 in common.

In the present disclosure, a system includes the training information providing system 500 according to this embodiment. a storage unit includes the server 4 (particularly storage device 43) of this embodiment, and a display unit includes the display 15 of the kiosk terminal 1 according to this embodiment. A printing unit includes the printer 17 of the kiosk terminal 1 according to this embodiment. A scanning unit includes the reading device 18 of the kiosk terminal 1 according to this embodiment. A processing unit includes the server 4 (particularly processor 41) according to this embodiment.

An identification information includes the training ID exemplified in FIG. 7 according to this embodiment (also the trainer ID or the combination of the training ID and the trainer ID depending on a mode). Advisory information includes information which contains respective information on the name, the purpose of training, task, and solution exemplified in FIG. 7 according to this embodiment. Although respective information such as information on the content of training and information on solution are explained only with respect to text data in this embodiment, image data such as drawings may be also contained as such information.

Although a QR code is used as one example of identification information of a machine readable type in this embodiment, a bar code or a text of identification information may be directly printed as it is. When the identification information is a text, the identification information can be read by a machine by analyzing using an OCR technique.

A format in which the evaluation by a user is filled corresponds to a free filling format or an evaluation score filling format of a computer-scored answer sheet form in this embodiment. Evaluation information corresponds to the respective information on the evaluation score and the comment shown in FIG. 9 and FIG. 10 according to this embodiment. Although the explanation has been made with respect to the case where the evaluation information and the first information are stored in the same storage device 43 according to this embodiment, the evaluation information and the first information may be stored in the different storage parts.

A terminal device includes the support terminal 3 according to this embodiment, and the second terminal corresponds to the program input terminal 2 according to this embodiment.

As has been explained in detail heretofore, according to the technique described in this specification, the system can efficiently support a user who uses a facility.

In the disclosed embodiments, processing can be accomplished by a computer-executable program, and this program can be realized in a computer-readable memory device. In the disclosed embodiments, a memory device, such as a magnetic disk, a flexible disk, a hard disk, an optical disk (CD-ROM, CD-R, DVD, and so on), an optical magnetic disk (MD and so on), can be used to store instructions for causing a processor or a computer to perform the processes described above. Furthermore, based on an instruction of the program installed from the memory device to the computer, OS (operation system) operating on the computer, or MW (middleware software), such as database management software or network, may execute one part of each processing to realize the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for providing a user with information, the method comprising:
storing one or more pieces of advisory information and identification information of each of the advisory information;
recognizing a request for advisory information from the user;
forming, on a sheet, the advisory information requested by the user, an image corresponding to the identification information of the requested advisory information, and an input region in which feedback from the user can be provided;
scanning the image formed on the sheet and the input region in which the user has provided the feedback; and
storing the feedback in association with the corresponding advisory information.

2. The method according to claim 1, wherein
the feedback is stored in association with the corresponding advisory information based on the identification information of the advisory information recognized based on the scanned image.

3. The method according to claim 1, further comprising:
displaying the feedback on a display unit in response to a request for the feedback.

4. The method according to claim 3, wherein
the advisory information is formed on a sheet by a service terminal device located in a facility, and
the display unit is included in a mobile device an advisor who created the advisory information carries.

5. The method according to claim 4, wherein
the service terminal device and the mobile device are connected through a network.

6. The method according to claim 1, wherein
each of the advisory information includes a unique training program and a purpose corresponding to the unique training program, and the method further comprising:
displaying the purposes such that the user selects one or more of the purposes,
wherein the advisory information is formed on the sheet in response to the user selecting a corresponding purpose.

7. The method according to claim 1, wherein
the advisory information is stored with problem information associated with the advisory information and solution information associated with the problem information, and the method further comprising:
displaying the problem information and the solution information corresponding to the advisory information being requested by the user.

8. The method according to claim 7, wherein
the advisory information is formed on a sheet by a service terminal device located in a facility, and
the problem information and the solution information are displayed on a display unit of a mobile device an assistant who assists the user carries.

9. A system configured to provide a user with information, comprising:
a storage unit configured to store one or more pieces of advisory information and identification information of each of the advisory information;
a processing unit configured to recognize a request for the advisory information from the user;
a printing unit configured to form, on a sheet, advisory information requested by the user, an image corresponding to the identification information of the requested advisory information, and an input region in which a feedback from the user can be provided; and
a scanning unit configured to scan the image formed on the sheet and the input region in which the user has provided the feedback,
wherein the storage unit is configured to store the feedback in association with the corresponding advisory information.

10. The system according to claim 9, wherein
the processing unit is configured to recognize the identification information of the advisory information based on the scanned image, and
the feedback is associated with the corresponding advisory information based on the identification information.

11. The system according to claim 9, further comprising:
a display unit configured to be carried independently from the printing unit, and to display the feedback in response to a request for the feedback.

12. The system according to claim 11, wherein
the printing unit is included in a service terminal device located in a facility; and
the display unit is included in a mobile device an advisor who created the advisory information carries.

13. The system according to claim 12, wherein
the service terminal device and the mobile device are connected through a network.

14. The system according to claim 9, wherein
each of the advisory information includes a unique training program and a purpose corresponding to the unique training program, and the system further comprising:
a display unit configured to display the purposes such that the user selects one or more of the purposes,
wherein the printing unit is configured to form on the sheet the advisory information in response to the user selecting a corresponding purpose.

15. The system according to claim 9, wherein
the advisory information is stored with problem information associated with the advisory information and solution information associated with the problem information, and the system further comprising:
a display unit configured to display the problem information and the solution information corresponding to the advisory information being requested by the user.

16. The system according to claim 15, wherein
the printing unit is includes in a service terminal device located in a facility, and
the display unit is included in a mobile device an assistant who assists the user carries.

17. A service terminal device configured to provide a user with information, the device comprising:
a processing unit configured to recognize a request for advisory information from the user;
a printing unit configured to form, on a sheet, the advisory information requested by the user, an image corresponding to an identification information of the requested advisory information, and an input region in which a feedback from the user can be provided; and
a scanning unit configured to scan the image and the feedback formed on the sheet,
wherein the processing unit is configured to recognize the identification information of the advisory information based on the scanned image, and to associate the feedback with the corresponding advisory information based on the identification information.

18. The service terminal device according to claim 17, wherein
the advisory information includes a unique training program and a purpose corresponding to the unique training program, and the device further comprising:
a display unit configured to display the purposes such that the user selects one or more of the purposes,
wherein the printing unit is configured to form on the sheet the advisory information in response to the user selecting a corresponding purpose.

19. The service terminal device according to claim 17, wherein
the processing unit is configured to convert the feedback scanned by the scanning unit to a text data.

20. The service terminal device according to claim 17, further comprising:
a network interface through which the service terminal device is connected to a storage device, wherein
the processing unit is configured to cause the feedback to be transmitted to the storage device.
